(19) United States
(12) Patent Application Publication
(10) Pub. No.: US 2008/0051053 A1
(43) Pub. Date: Feb. 28, 2008

(54) Dynamic, low if, image interference avoidance receiver

(76) Inventor: Orest Fedan, Belmont, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/509,287

(22) Filed: Aug. 24, 2006

(51) Int. Cl. H04B 1/10

(52) U.S. Cl. 455/296

(57) ABSTRACT

A dynamic low IF image interference avoidance receiver shifts the local oscillator frequency to avoid image interference and shifts the center frequency of the band pass filter to track the frequency shift of the local oscillator or uses two local oscillators, a first to shift frequency and separate the desired frequency and image interference frequency and the second to track the first and maintain the output IF at a fixed frequency

### FIELD OF THE INVENTION

This invention relates to a dynamic, low IF, image interference avoidance receiver.

### BACKGROUND OF THE INVENTION

The applicant's successful and popular vehicle recovery system sold under the trademark LoJack® includes a small electronic vehicle locating unit (VLU) with a transponder hidden within a vehicle, a private network of communication towers each with a remote transmitting unit (RTU), one or more law enforcement vehicles equipped with a vehicle tracking unit (VTU), and a network center with a database of customers who have purchased a VLU. The network center interfaces with the National Criminal Information Center. The entries of that database comprise the VIN number of the customer's vehicle and an identification code assigned to the customer's VLU.

When a LoJack® product customer reports that her vehicle has been stolen, the VIN number of the vehicle is reported to a law enforcement center for entry into a database of stolen vehicles. The network center includes software that interfaces with the database of the law enforcement center to compare the VIN number of the stolen vehicle with the database of the network center which includes VIN numbers corresponding to VLU identification codes. When there is a match between a VIN number of a stolen vehicle and a VLU identification code, as would be the case when the stolen vehicle is equipped with a VLU, and when the center has acknowledged the vehicle has been stolen, the network center communicates with the RTUs of the various communication towers (currently there are 130 nationwide) and progressively each tower transmits a message to activate the transponder of the particular VLU bearing the identification code.

The transponder of the VLU in the stolen vehicle is thus activated and begins transmitting its unique VLU identification code. The VTU of any law enforcement vehicles proximate the stolen vehicle receive this VLU transponder code and, based on signal strength and directional information, the appropriate law enforcement vehicle can take active steps to recover the stolen vehicle. See, for example, U.S. Pat. Nos. 4,177,466; 4,818,988; 4,908,609; 5,704,008; 5,917,423; 6,229,988; 6,522,698; and 6,665,613 all incorporated herein by this reference.

The receiver in the VLU is typically a superheterodyne receiver set to receive the assigned frequency e.g. 170 MHz. The local oscillator (LO) is set to 150 MHz so the intermediate frequency (IF) is 20 MHz and the interfering image frequency appears e.g., at 130 MHz. The image interference is removed with an IMAGE INTERFERENCE filter of e.g. 80 MHz bandwidth. While this approach works well, it has shortcomings. To begin with it requires an IMAGE INTERFERENCE filter. It also requires an expensive crystal filter element due to the high IF frequency and amplification at the high (20 MHz) IF frequency draws substantial current. While a spread spectrum or frequency hopping approach ordinarily would be an option to remove or avoid the interference associated with the image frequency while at the same time using a low IF frequency, it is not an option in this application or any application where the assigned frequency is fixed as in the LoJack VLU.

### SUMMARY OF THE INVENTION

It is therefore an object of this invention to provide a dynamic, low IF, image interference avoidance receiver.

It is a further object of this invention to provide such a dynamic, low IF, image interference avoidance receiver which is smaller in size, consumes less power, and is less expensive.

It is a further object of this invention to provide such a dynamic, low IF, image interference avoidance receiver which can utilize much less expensive, fixed, band pass filtering.

It is a further object of this invention to provide such a dynamic, low IF, image interference avoidance receiver which can eliminate the image interference filter.

The invention results from the realization that a dynamic, low IF, image interference avoidance receiver which eliminates the need for the image interference filter and is smaller, less expensive and less power consuming can be effected by shifting the local oscillator frequency to avoid image interference and also shifting the center frequency of the IF band pass filter to track the frequency shift of the local oscillator, or by using two shifted local oscillators, a first to avoid image interference and a second to track the first and maintain the output IF at a fixed frequency.

The subject invention, however, in other embodiments, need not achieve all these objectives and the claims hereof should not be limited to structures or methods capable of achieving these objectives.

This invention features a dynamic low IF image interference avoidance receiver including a programmable local oscillator for providing a local oscillator frequency and a mixer responsive to the local oscillator frequency and input signal frequency to provide an intermediate signal frequency which is the sum or difference between the local oscillator frequency and the input signal frequency. There is a tracking programmable band pass filter responsive to the intermediate signal frequency to produce a filtered intermediate signal and a detector responsive to the filtered intermediate signal for determining the presence of interference. A controller responsive to the detector determining the presence of interference shifts both the local oscillator frequency of the programmable local oscillator and the center frequency of the tracking programmable band pass filter to maintain the intermediate signal frequency centered on the center frequency of the tracking programmable bandpass filter.

In a preferred embodiment the mixer may include a Gilbert cell. The detector may include a received signal strength indicator (RSSI). The controller may include a microprocessor. The tracking programmable band pass filter may include a switched capacitor filter with programmable center frequency. The tracking programmable band pass filter may include a DSP band pass filter. The DSP band pass filter may have an IIR or an FIR response. The tracking programmable band pass filter may include an inductor or inductor equivalent circuit and a varactor or a transductor and a capacitor.

This invention also features a dynamic low IF image interference avoidance receiver including a first programmable local oscillator for producing a local oscillator frequency and first mixer responsive to the local oscillator frequency and an input signal frequency to provide an intermediate signal frequency which is the sum or difference between the local oscillator frequency and the input signal frequency. There is a fixed low pass filter responsive to the intermediate signal frequency to produce a filtered intermediate signal frequency and a second programmable local oscillator for providing a second local oscillator frequency. A second mixer responsive to the second local oscillator frequency and the filtered intermediate signal frequency produces a second intermediate signal frequency which is the sum or difference of the filtered intermediate signal frequency and the second local oscillator frequency. A fixed band pass filter is responsive to the second intermediate signal frequency to produce a filtered second intermediate signal. There is a detector responsive to the filtered second intermediate signal for determining the presence of interference. A controller responsive to the detector determining the presence of interference shifts both local oscillator frequencies to maintain the second intermediate signal frequency centered on the center frequency of the fixed band pass filter.

In a preferred embodiment the first mixer may include a Gilbert cell; the second mixer may include a Gilbert cell. The detector may include a received signal strength indicator. The controller may include a microprocessor.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram for a dynamic, low IF, image interference avoidance receiver according to this invention;

FIG. 2 is illustrates the frequency distribution of pertinent signals in a prior art receiver;

FIGS. 3-5 illustrate the frequency distribution of pertinent signals in the receiver of FIG. 1;

FIG. 6 is a schematic block diagram of another embodiment of a dynamic, low IF, image interference avoidance receiver according to this invention;

FIGS. 7-11 illustrate the frequency distribution of pertinent signals in the receiver of FIG. 6; and

FIGS. 12-15 are block diagrams of implementations of the tracking band pass filter of FIG. 1.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

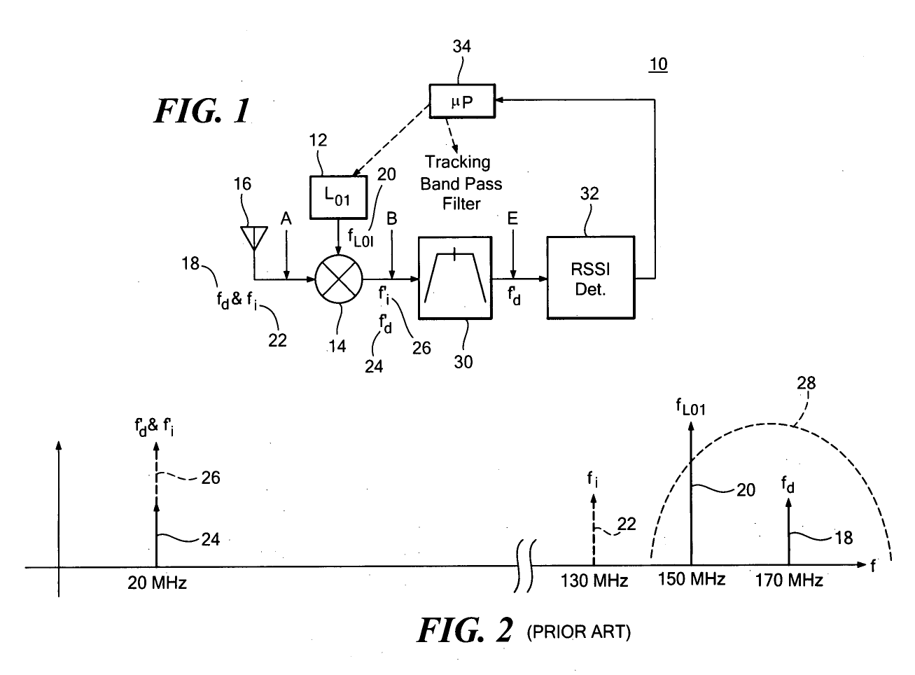

There is shown in FIG. 1 a dynamic low IF image interference avoidance receiver 10 according to this invention. There is a first local oscillator 12 and a first mixer 14. Antenna 16 receives an incoming signal which may include a desired signal frequency f_{d} 18 and the image interference frequency fᵢ 22. These are beat or mixed together with the local oscillator frequency f_{L01} 20 in mixer 14 to provide the corresponding difference signals f′_{d} 24 and f′ᵢ 26 as shown in FIG. 2. In a conventional prior art approach where the desired signal frequency f_{d} is 170 MHz, local oscillator frequency f_{L01} is chosen to be 150 MHz. The difference between the local oscillator frequency f_{L01} and the desired signal frequency f_{d} is thus 20 MHz. The corresponding difference signals f′_{d} 24 and f′ᵢ 26 both occur at 20 MHz as indicated in FIG. 2. Again, in accordance with the prior art, a band pass filter, having a characteristic such as shown in dashed lines 28 generally centered on the desired signal frequency f_{d} 18 and excluding the image interference frequency fᵢ 22, is used to reject the image interference.

In accordance with this invention a tracking programmable band pass filter 30, FIG. 1, is used in conjunction with a received signal strength indicator (RSSI) 32 and a controller 34 such as a microprocessor. The tracking programmable band pass filter may include an inductor or inductor equivalent circuit and a varactor or a transductor and a capacitor. In operation microprocessor 34 may be programmed to recognize the normal thermal noise level output at RSSI detector 32 and to regard any signals from RSSI detector 32 a safe level above the thermal noise level as an indication that image interference is occurring. Microprocessor 34 then steps the local oscillator frequency f_{L01} of local oscillator 12 up or down a fixed amount, for example, 0.1 MHz and keeps doing this until a frequency is found where the image interference is no longer a factor. In the particular application in a LoJack VLU, microprocessor 34 would sample the incoming signal at a rate that is higher than the normal LoJack communication rate, e.g. 2 times per second. If the signal form the RSSI detector 32 is high for two samples in a row, it would be apparent that one of those was interference and microprocessor 34 would drive local oscillator 12 to another frequency channel. At the same time microprocessor 34 steps local oscillator 12 to a new frequency channel, it also steps tracking programmable band pass filter 30 a corresponding amount so that filter 30 stays at the frequency f′_{d} of the desired difference signal. This maintains the intermediate signal frequency centered on the center frequency of the tracking programmable band pass filter. It should be understood that whenever two signals are mixed together the resulting signals will include the signal frequencies themselves as well as the sum and the difference frequencies of those signals. Here the discussion is restricted to the difference frequency.

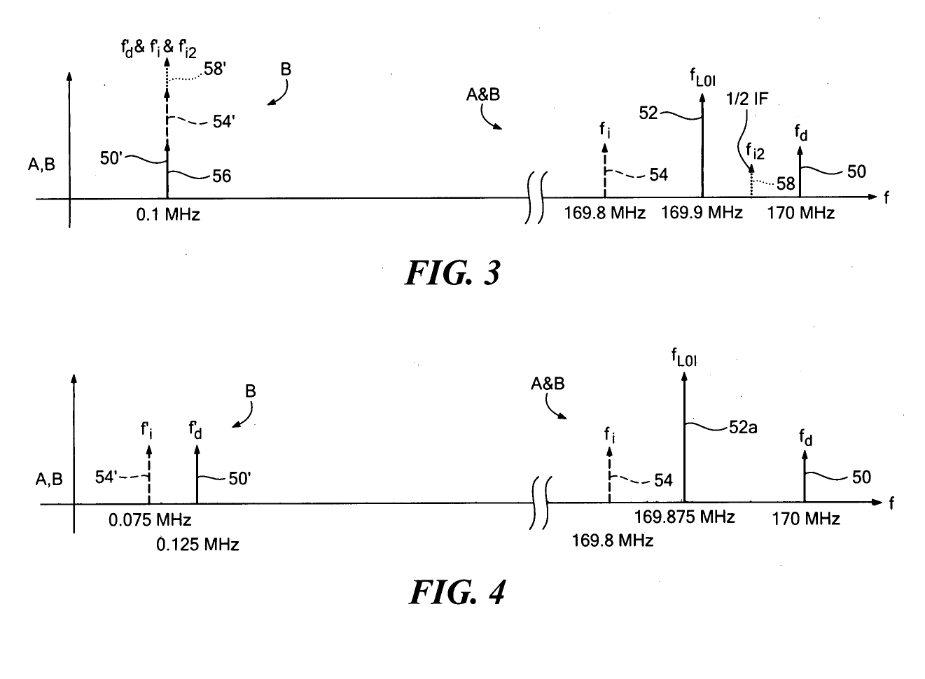

The operation of dynamic low IF image interference avoidance receiver 10, FIG. 1, can be better understood with reference to FIGS. 3, 4, and 5. Initially, for example, with a desired signal frequency, f_{d} 50 of 170 MHz and a local oscillator frequency f_{L01} 52 of 169.9 MHz and image interference frequency fᵢ 54 of 169.8 MHz, the difference signals at 0.1 MHz or 100 kHz occur at 56 showing the combined signals f′_{d} 50′ and f′ᵢ 54′. In FIGS. 1-5 and again in FIGS. 6-11 the designation A-E refers to the signals. Although in FIGS. 2 and 3 the local oscillator frequency f_{L01} is shown at a lower frequency than the desired signal frequency f_{d} with the image interference frequency fᵢ lower than both, this is not a necessary limitation of the invention. For example, in FIG. 3, the local oscillator frequency f_{L01} could be above the desired signal frequency f_{d}. For example, it could be at 170.1 MHz and the image interference frequency fᵢ could be at 170.2 MHz. Likewise in FIG. 2 the local oscillator frequency at 20 of 150 MHz could instead be set to 190 MHz while the image interference frequency fᵢ 22 would then be 210 MHz.

Continuing with the explanation of the operation of FIG. 1, while thus far the only interference considered has been the image interference frequency fᵢ 54 and the corresponding difference signal f′ᵢ 54′, it may as well include other interference elements such as for example, the half IF frequency fᵢ₂ 58, FIG. 3, which would further add to the signal 56 as shown at 58′.

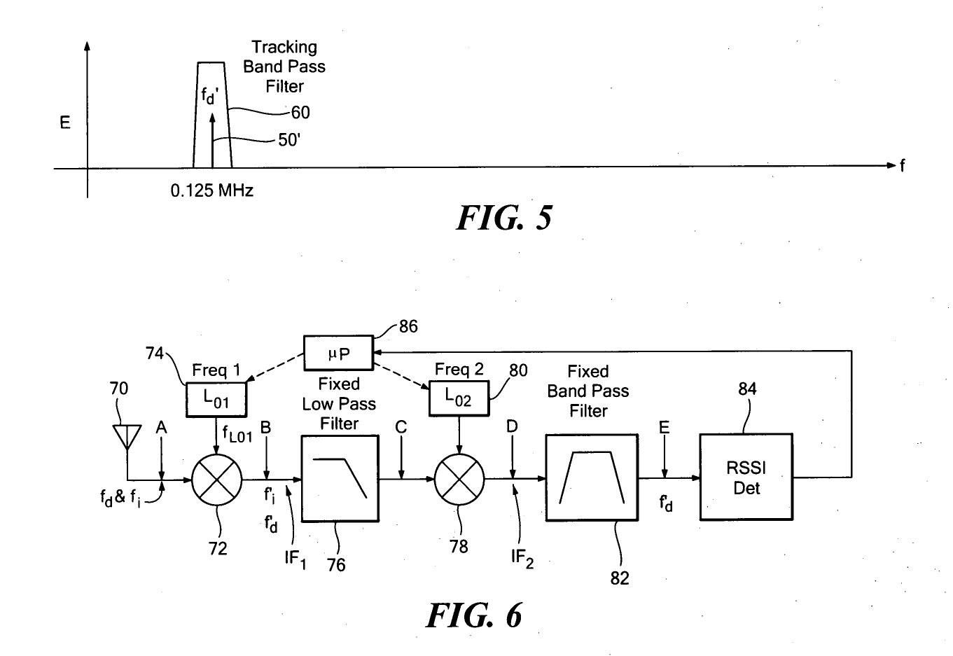

In accordance with this invention, without attempting to provide a filter characteristic, such as shown at 28 in FIG. 2, this receiver completely avoids the image interference by shifting the frequency of local oscillator 12 as shown in FIG. 4 where that frequency f_{L01} is now shown at 52a as 169.875 MHz. The desired signal frequency f_{d} 50 is still 170 MHz and the image interference frequency is still 169.8 MHz as shown at 54. But now the difference between the local oscillator frequency f_{L01} 52a and the desired signal frequency f_{d} 50 is different than the difference between the local oscillator frequency f_{L01} 52a and the image interference frequency fᵢ 54. The difference of the former is 0.125 MHz whereas the difference between the new local oscillator frequency f_{L01} 52a and the image interference frequency fᵢ 54 is now only 0.075 MHz, or 75 kHz; f′ᵢ is shown at 54′. That is the two instead of being coincident are now separated by 50 kilohertz. Although in FIG. 4, the local oscillator frequency was shifted down to separate the desired and interference signals, this is not a necessary limitation of this invention. For example, the local oscillator could have been shifted up to 169.925 MHz, in which case f′ᵢ and f′_{d} in FIG. 4 would exchange places. Now the tracking programmable band pass filter 30, FIG. 1, can easily be made to pass f′_{d} 50′ the 125 KHz signal and block passage of the displaced image interference frequency f′ᵢ 54′ shown in FIG. 4 and now eliminated in FIG. 5. The tracking band pass filter 30 characteristic is shown at 60, FIG. 5.

Thus, in the embodiment of the invention shown in FIG. 1 controller 34 drives tracking band pass filter 30 to maintain its center frequency centered on the frequency of the desired signal f′_{d} 50′ and the local oscillator 12 is shifted as necessary to avoid the image interference frequency fᵢ. This is not a necessary limitation of the invention, however. For in another embodiment, as shown in FIG. 6, instead of controlling a tracking band pass filter, a second local oscillator is controlled to shift its frequency in correspondence with that of the first local oscillator thereby maintaining the final or second intermediate frequency output at a fixed frequency which is easily filtered by a fixed band pass filter. The first intermediate frequency filter is also fixed and can use a fixed low pass filter.

In FIG. 6 an input signal from antenna 70 includes both the desired signal frequency f_{d} and the image interference frequency fᵢ but may also be composed of more elements as explained previously. This is delivered to mixer 72 which also receives the first local oscillator frequency f_{L01} from first local oscillator 74 and provides as an output the corresponding difference signals f′_{d} and f′ᵢ of the desired signal frequency f_{d} and image interference frequency fᵢ, respectively as a first intermediate frequency signal. This intermediate frequency signal or IF₁ signal is submitted to low pass filter 76 which filters out frequencies above the intermediate frequency. The filtered intermediate frequency signal is delivered to a second mixer 78 which also receives an input from a second local oscillator 80. This produces a second intermediate frequency signal or IF₂ signal to fixed band pass filter 82. The filtered second intermediate frequency signal is delivered to a detector 84 such as an RSSI detector whose output is delivered to the controller 86 as previously explained with respect to controller 34 in FIG. 1. Now, however, controller 86 here again implemented by a microprocessor controls local oscillator 74 and not a filter but the second local oscillator 80. In this way when the first local oscillator 74 is shifted by microprocessor 86 in order to find a channel with little or no image interference, microprocessor 86 operates, not to shift a filter to track the shift in frequency of local oscillator 74, but rather to drive the second local oscillator 80 to shift the frequency of the IF₂ signal creating an IF₂ signal which remains fixed so that the frequency of the signal at the input to band pass filter 82 remains fixed regardless of the shifting of local oscillator 74.

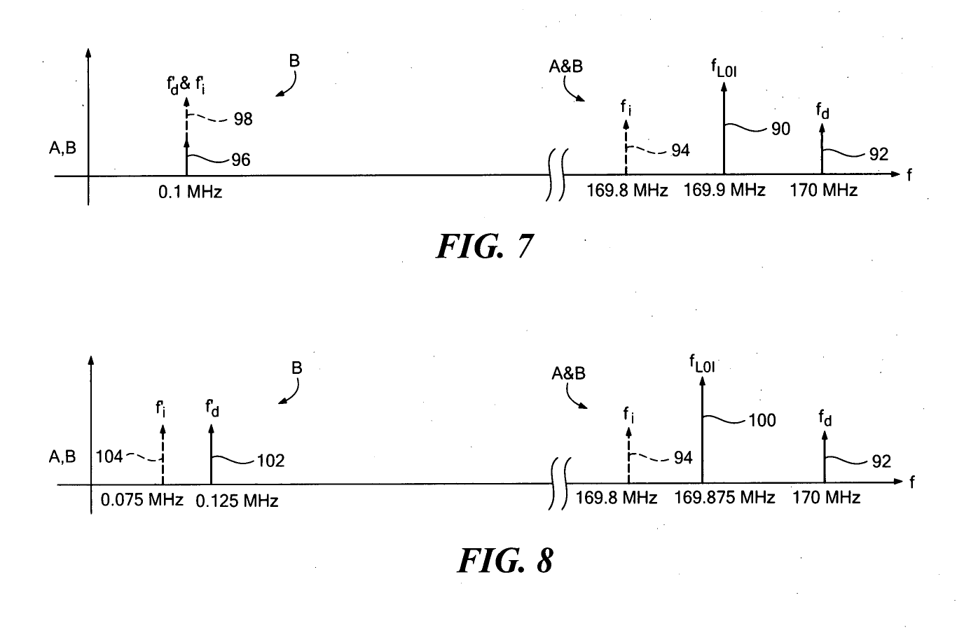

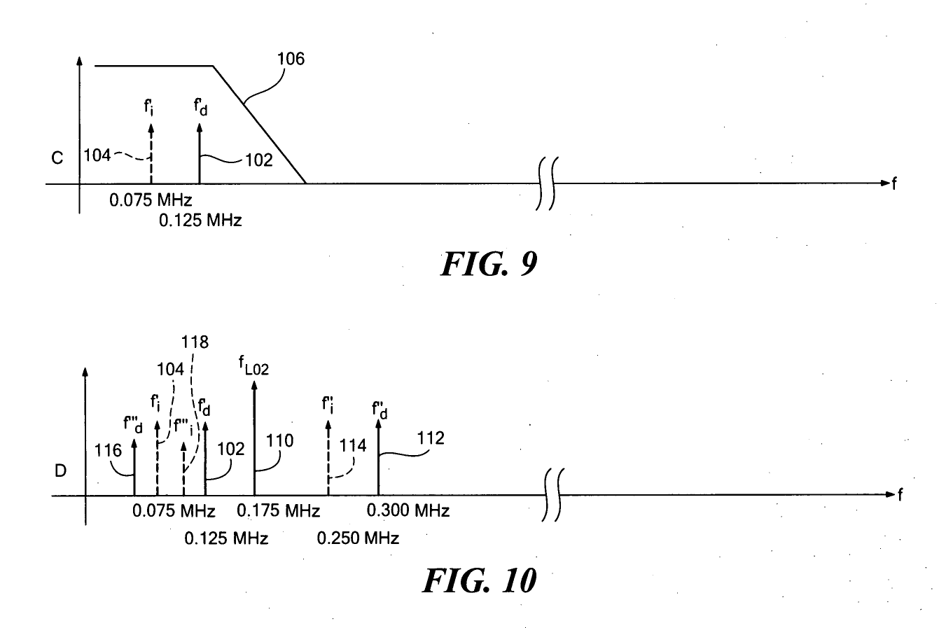

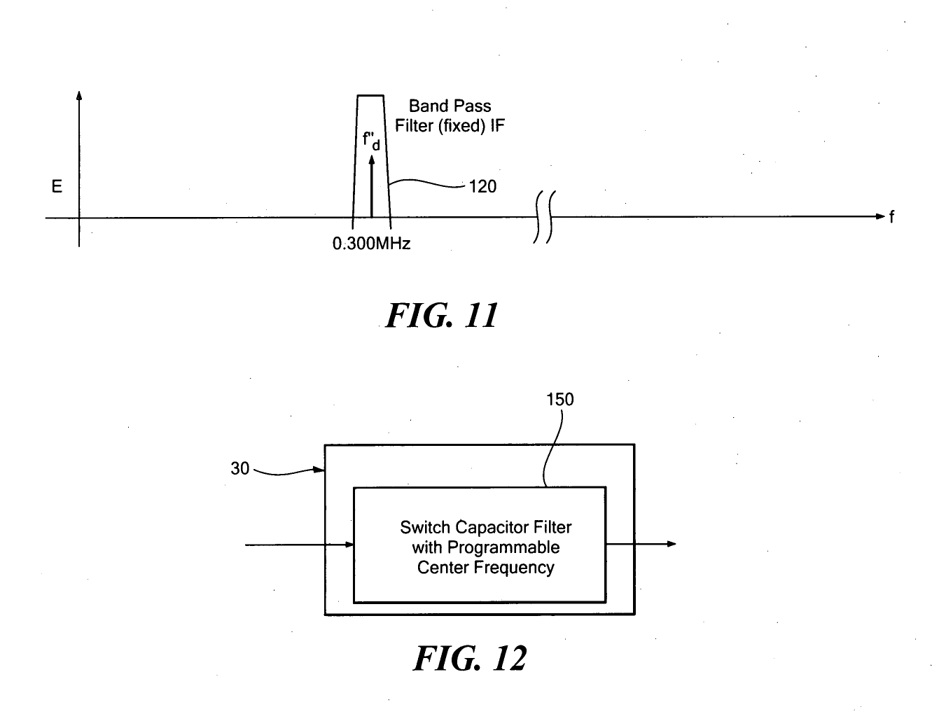

This can be seen more clearly by reference to FIGS. 7, 8, 9 and 10. In FIG. 7, as explained earlier with respect to FIG. 3, the first local oscillator frequency f_{L01} 90, is 169.9 MHz. The desired frequency f_{d} 92 is 170 MHz. The image interference frequency fᵢ 94 is 169.8 MHz so that the difference signals corresponding to the desired frequency f′_{d} and image interference frequency f′ᵢ, respectively, are coincident at the difference of 0.1 MHz or 100 kHz as indicated at 96 and 98, respectively. To avoid this once again the frequency of the first oscillator f_{L01} is shifted from 169.9 MHz in FIG. 7 to 169.875 MHz in FIG. 8 as indicated at 100, but the frequency of the local oscillator may also have been shifted to 169.925 MHz as explained previously. The desired frequency of f_{d} remains as indicated at 92 at 170 MHz and image interference frequency fᵢ remains at 94 at 169.8 MHz. That shift has now caused a greater frequency difference f′_{d} 102 of 0.125 MHz in the desired signal and a smaller frequency difference 0.75 MHz in the image interference f′ᵢ 104. Thus the interfering signal f′ᵢ 104 has been separated from the desired signal f′_{d} 102. Next, all the higher frequency signals 94, 100, 92, are eliminated by the fixed low pass filter 76, FIG. 6 whose characteristic envelope is shown at 106, FIG. 9. This results in a filtered IF₁ signal which is delivered to mixer 78 where it is mixed with the second local oscillator frequency from the second local oscillator 80. The second local oscillator frequency f_{L02}, 110, FIG. 10, being beat or mixed in mixer 78 with the filtered IF₁ signal produces the sum frequencies f″_{d} 112 and f′ᵢ 114 and also the difference frequencies f′″_{d} 116 and f′″ᵢ 118. The shifting of the frequency of the second local oscillator 80 in correspondence with the shifting of the frequency of the first local oscillator 74 results in f″_{d} always being fixed in frequency so that the band pass filter 82 can have a fixed band pass envelope 120, FIG. 11, which selects out the desired signal f″_{d} and blocks the others.

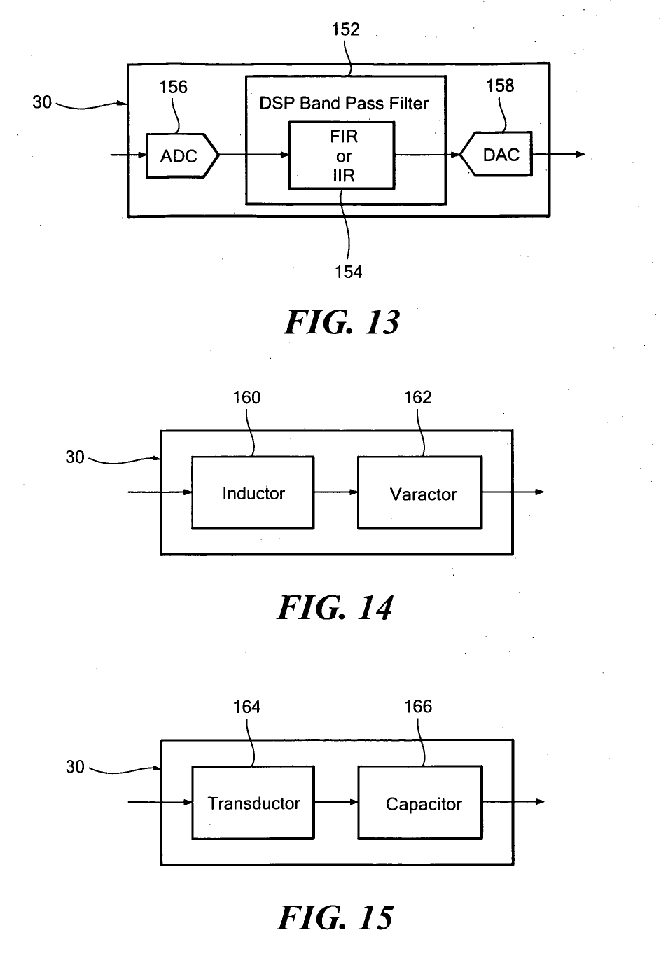

The tracking band pass filter 30, FIG. 1, can be constructed in a number of ways. For example, it could be implemented with a switched capacitor filter with programmable center frequency 150, FIG. 12. For further explanation see Analog MOS Integrated Circuits for Signal Processing, by Roubik Gregorian and Gabor C. Temes. Or it could be implemented as shown in FIG. 13 using a DSP band pass filter 152 utilizing either a finite impulse response (FIR) filter or an infinite impulse response (IIR) filter 154 with an analog to digital converter 156 at the input and a digital to analog converter 158 at the output. For further explanation see Software Radio A Modern Approach to Radio Engineering by Jeffrey H. Reed. Both the implementations of FIG. 12 and FIG. 13 may be on-chip implementations. FIG. 14 shows another implementation for tracking band pass filter 30 which may be off-chip and uses an inductor 160 and varactor 162. For further explanation see Design of a Simple Tunable/Switchable Bandpass Filter by K. Jeganathan, National University of Singapore, Applied Microwave & Wireless, March 2000, pages 32-40.

FIG. 15 shows another implementation for tracking bandpass filter 30 which may be off-chip and uses a transductor 164 and a capacitor 166. For further explanation see The Forgotten Use of Saturable Core Inductors (Transductors), by Christopher Trask, ATG Design Services, Applied Microwave and Wireless, September/October 1997.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A dynamic, low IF, image interference avoidance receiver comprising:
a programmable local oscillator for producing a local oscillator frequency:
a mixer responsive to said local oscillator frequency and an input signal frequency to provide an intermediate signal frequency which is the sum or difference between said local oscillator frequency and said input signal frequency:
a tracking programmable band pass filter responsive to said intermediate signal frequency to produce a filtered intermediate signal;
a detector responsive to said filtered intermediate signal for determining the presence of interference; and
a controller responsive to said detector determining the presence of interference for shifting both the local oscillator frequency of said programmable local oscillator and the center frequency of said tracking programmable band pass filter to maintain the intermediate signal frequency centered on the center frequency of said tracking programmable bandpass filter.

2. The dynamic, low IF, image interference avoidance receiver of claim 1 in which said mixer includes a Gilbert cell.

3. The dynamic, low IF, image interference avoidance receiver of claim 1 in which said detector includes a received signal strength indicator (RSSI).

4. The dynamic, low IF, image interference avoidance receiver of claim 1 in which said controller includes a microprocessor.

5. The dynamic, low IF, image interference avoidance receiver of claim 1 in which said tracking programmable band pass filter includes a switched capacitor filter with programmable center frequency.

6. The dynamic, low IF, image interference avoidance receiver of claim 1 in which said tracking programmable band pass filter includes a DSP band pass filter.

7. The dynamic, low IF, image interference avoidance receiver of claim 6 in which said tracking programmable band pass filter has an infinite impulse response (IIR).

8. The dynamic, low IF, image interference avoidance receiver of claim 6 in which said tracking programmable band pass filter has a finite impulse response (FIR).

9. The dynamic, low IF, image interference avoidance receiver of claim 1 in which said tracking programmable band pass filter includes an inductor or inductor equivalent circuit and a varactor.

10. The dynamic, low IF, image interference avoidance receiver of claim 1 in which said tracking programmable bandpass filter includes a transductor and a capacitor.

11. A dynamic, low IF, image interference avoidance receiver comprising:
a first programmable local oscillator for producing a local oscillator frequency:
a first mixer responsive to said local oscillator frequency and an input signal frequency to provide an intermediate signal frequency which is the sum or difference between said local oscillator frequency and said input signal frequency:
a fixed low pass filter responsive to said intermediate signal frequency to produce a filtered intermediate signal frequency;
a second programmable local oscillator, for producing a second local oscillator frequency;
a second mixer responsive to said second local oscillator frequency and said filtered intermediate signal frequency for producing a second intermediate signal frequency which is the sum or difference between said filtered intermediate signal frequency and said second local oscillator frequency;
a fixed band pass filter responsive to said second intermediate signal frequency to produce a filtered second intermediate signal;
a detector responsive to said filtered second intermediate signal for detecting the presence of interference; and
a controller responsive to said detector determining the presence of interference for shifting both local oscillator frequencies to maintain the second intermediate signal frequency centered on the center frequency of said fixed band pass filter.

12. The dynamic, low IF, image interference avoidance receiver of claim 11 in which said first mixer includes a Gilbert cell.

13. The dynamic, low IF, image interference avoidance receiver of claim 11 in which said detector includes a received signal strength indicator (RSSI).

14. The dynamic, low IF, image interference avoidance receiver of claim 11 in which said second mixer includes a Gilbert cell.

15. The dynamic, low IF, image interference avoidance receiver of claim 11 in which said controller includes a microprocessor.
